(19) United States
(12) Patent Application Publication
(10) Pub. No.: US 2011/0164573 A1
(43) Pub. Date: Jul. 7, 2011

(54) METHOD AND APPARATUS FOR ASSIGNING CHANNEL IN AD-HOC NETWORK

(75) Inventors: Jongyoung Lee, Daejeon-city (KR); Hoon Jeong, Daejeon-city (KR); Jong-Jun Park, Gyeougsan-city (KR); Sun-Joong Kim, Daejeon-city (KR); Cheol-Sig Pyo, Daejeon-city (KR); Jong-Suk Chae, Daejeon-city (KR)

(73) Assignee: Electronics and Telecommunications Research Institute, Daejeon-city (KR)

(21) Appl. No.: 12/596,832

(22) PCT Filed: Oct. 24, 2007
(86) PCT No.: PCT/KR2007/005266

§ 371 Date: Oct. 20, 2009

(30) Foreign Application Priority Data
Apr. 30, 2007 (KR) 10-2007-0042077

(51) Int. Cl. H04W 72/04

(52) U.S. Cl. 370/329

(57) ABSTRACT

The present invention provides a method and apparatus for assigning a channel in an ad-hoc network, which can minimize beacon collision in the ad-hoc network and prevent channel overlapping or collision, and thus a channel can be efficiently assigned. The method of assigning a channel including: obtaining join order information which is information on the order in which a first node has been joined to a second node, which is a parent node, and level information of the second node in an ad-hoc network; determining a reference value for setting a channel that is to be assigned to the first node based on an address value of the first node, which is determined based on the join order information and the level information, a level value of the first node, a channel value of the second node, which is determined based on the level information, and the join order information; and determining a channel value of the first node by dividing the reference value by the maximum number of usable channels in the ad-hoc network.

### TECHNICAL FIELD

The present invention relates to a method and apparatus for assigning a channel in an ad-hoc network, and more particularly, to a method and apparatus for assigning a channel to a node based on a current level of the node, a channel value of a parent node, information on the order in which the node has been joined to the parent node, and the maximum number of usable channels, and preventing overlapping of channels. This work was supported by the IT R&D program of MIC/IITA.[2005-S038-02, Development of UHF RF-ID and Ubiquitous Networking Technology]

### BACKGROUND ART

According to Zigbee network topology, each node in a network system is classified into a Zigbee coordinator (ZC), a Zigbee router (ZR), and a Zigbee end device (ZE).

Here, the ZC is located on the top of a tree structure and manages the entire tree, the ZR is a lower node of the ZC and communicates with the ZC by using a beacon that is transmitted from the ZC, wherein the communication with the bottom nodes is possible by generating a beacon of the ZR at a time when the beacon of the ZR does not collide with the beacon of the ZC.

The ZE is located in the bottom of the Zigbee network topology and performs required data communication by using the beacon transmitted from the ZC or the ZR.

### DISCLOSURE OF INVENTION

### Technical Problem

In order to form such a tree structure, the ZC or the ZR transmits the beacon so as to communicate with other lower nodes. Here, if time of transmitting a beacon by each ZR is randomly selected, ZRs' beacons may collide in the lower nodes. When the beacons collide, communication between nodes is impossible.

Also, a sensor network forms a self-organizing network, and nodes of the sensor network become movable. Accordingly, when the sensor network is managed, a geographical distribution of the nodes cannot be pre-known, and a link or a channel cannot be pre-established. Since a method of suitably assigning a channel in such an ad-hoc network does not exist, such a method is required.

### Technical Solution

The present invention provides a method and apparatus for assigning a channel in an ad-hoc network, which can minimize beacon collision in the ad-hoc network and prevent channel overlapping or collision, and thus a channel can be efficiently assigned.

According to an aspect of the present invention, there is provided a method of assigning a channel, the method including: obtaining join order information which is information on the order in which a first node has been joined to a second node, which is a parent node, and level information of the second node in an ad-hoc network; determining a reference value for setting a channel that is to be assigned to the first node based on an address value of the first node, which is determined based on the join order information and the level information, a level value of the first node, a channel value of the second node, which is determined based on the level information, and the join order information; and determining a channel value of the first node by dividing the reference value by the maximum number of usable channels in the ad-hoc network.

According to another aspect of the present invention, there is provided an apparatus for assigning a channel, the apparatus including: a parent node information unit, which obtains join order information which is information on the order in which a first node has been joined to a second node, which is a parent node, and level information of the second node in an ad-hoc network; a reference value determiner, which determines a reference value for setting a channel that is to be assigned to the first node based on an address value of the first node, which is determined based on the join order information and the level information, a level value of the first node, a channel value of the second node, which is determined based on the level information, and the join order information: and a channel value determiner, which determines a channel value of the first node by dividing the reference value by the maximum number of usable channels in the ad-hoc network.

### Advantageous Effects

According to the method and apparatus for assigning a channel in an ad-hoc network of the present invention, whenever a new node is joined in the ad-hoc network, assigning a channel, which can minimize channel collision, is performed. Also, even if the same channel is assigned to different nodes, this can be detected and a new channel can be assigned. Accordingly, beacon collision in the ad-hoc network can be effectively prevented.

### DESCRIPTION OF DRAWINGS

The above and other features and advantages of the present invention will become more apparent by describing in detail exemplary embodiments thereof with reference to the attached drawings in which:

FIG. 1 is a diagram illustrating calculated address values of nodes in an ad-hoc network according to an embodiment of the present invention;

FIG. 2 is a diagram illustrating address values, level values, and join order values of nodes in an ad-hoc network according to an embodiment of the present invention;

FIG. 3 is a diagram illustrating calculated channel values of nodes in an ad-hoc network according to an embodiment of the present invention;

FIG. 4 is a flowchart illustrating a method of assigning a channel, which prevents channel overlapping, in an ad-hoc network according to an embodiment of the present invention;

FIG. 5 is a flowchart illustrating a method of assigning a channel for transmitting a beacon in an ad-hoc network according to an embodiment of the present invention; and

FIG. 6 is a diagram illustrating an apparatus for assigning a channel for transmitting a beacon in an ad-hoc network according to an embodiment of the present invention.

### BEST MODE

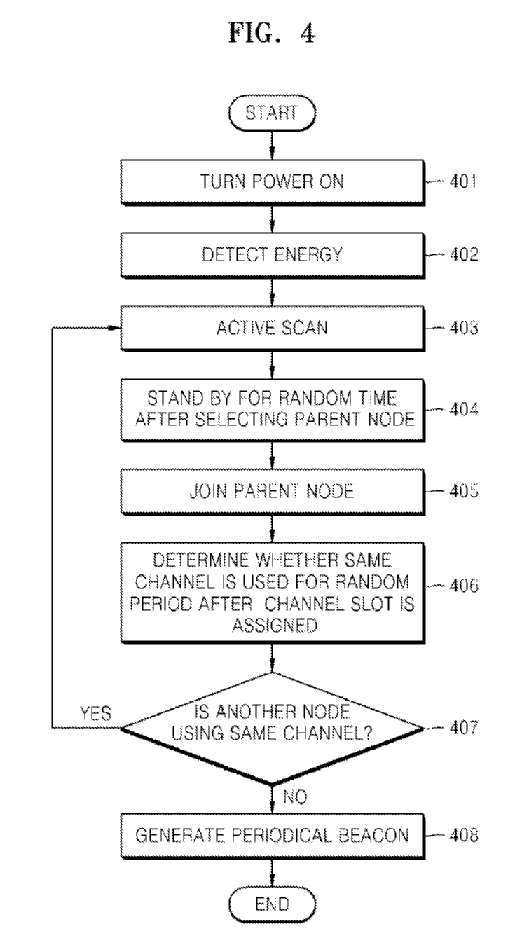

FIG. 4 is a flowchart illustrating a method of assigning a channel, which prevents channel overlapping, in an ad-hoc network according to an embodiment of the present invention.

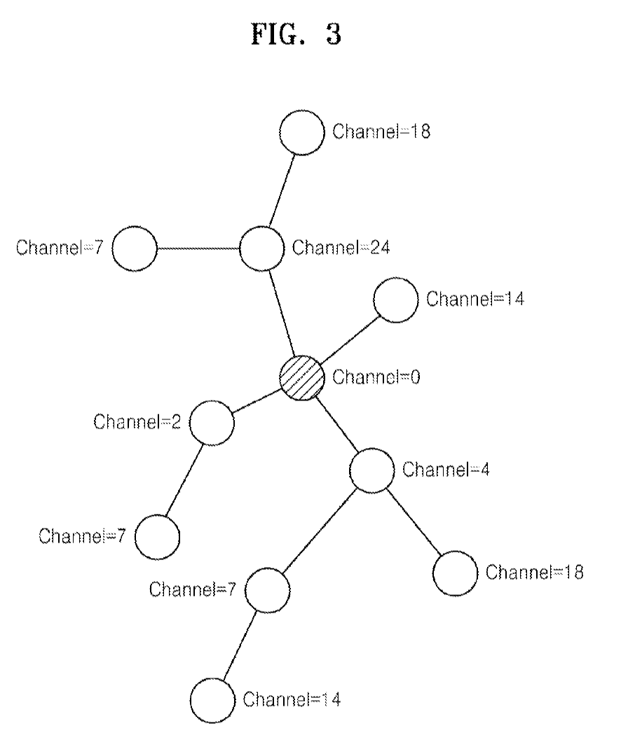

The method of FIG. 4 relates to a method of preventing channels, which are assigned according to the method of assigning a channel described in FIG. 3, from colliding or overlapping. The method of FIG. 4 can be largely classified into two types.

First, a child node searches for a parent node, and then before transmitting a join request message to the parent node, the child node stands by for a random time in order to differentiate a join order value which shows the order in which the child node has been joined to the parent node from join order values of other child nodes.

Second, after determining a channel of a node by the method of assigning a channel, it is checked whether another node is using the same channel during a predetermined beacon period before using the determined channel. If another node is using the same channel, the node is again joined to a parent node, and receives a different join order value from those of other child nodes, and thus the node can use a new channel.

Referring to FIG. 4, after power of a child node is turned on in operation 401, the child node selects a parent node by detecting energy of surroundings in operation 402 and actively scanning of the surroundings in operation 403. Here, before transmitting a join request message to the parent node, the child node stands by for a random time in operation 404. Accordingly, assigning different address values and join order values to child nodes simultaneously joining the parent node can be guaranteed.

Then, after joining the parent node in operation 405, a channel of the child node is assigned based not only on a current level of the child node, but also on the maximum number of usable channels, the maximum permissible level in the ad-hoc network, the maximum number of child nodes that the parent node can have, the maximum router number, and join order in which the child node has been joined to the parent node. Here, it is checked whether a channel assigned to the child node is used by another node during a suitable beacon period in operation 406.

When it is checked that the assigned channel is not used by another node in operation 407, the child node generates a beacon in the assigned channel in operation 408. However, when it is checked that the assigned channel is used by another node in operation 407, operation 403 is performed so that the child node again joins a parent node. In this case, even if the same parent node is selected, another channel is selected based on the method of assigning a channel since the parent node continuously increases the join order value. In other words, the parent node internally increases the join order value and since the parent node transmits the changed join order value to the child node, a channel value calculated according to the join order value also changes.

FIG. 6 is a diagram illustrating an apparatus 600 for assigning a channel for transmitting a beacon in an ad-hoc network according to an embodiment of the present invention.

Referring to FIG. 6, The apparatus 600 includes a parent node information unit 610, which obtains join order information which is information on the order in which a first node has been joined to a second node, which is a parent node, and level information of the second node in an ad-hoc network, a reference value determiner 620, which determines a reference value for setting a channel that is to be assigned to the first node based on an address value of the first node, which is determined based on the join order information and the level information, a level value of the first node, a channel value of the second node, which is determined based on the level information, and the join order information, and a channel value determiner 630, which determines a channel value of the first node by dividing the reference value by the maximum number of usable channels in the ad-hoc network.

### Mode for Invention

Hereinafter, the present invention will be described more fully with reference to the accompanying drawings, in which exemplary embodiments of the invention are shown.

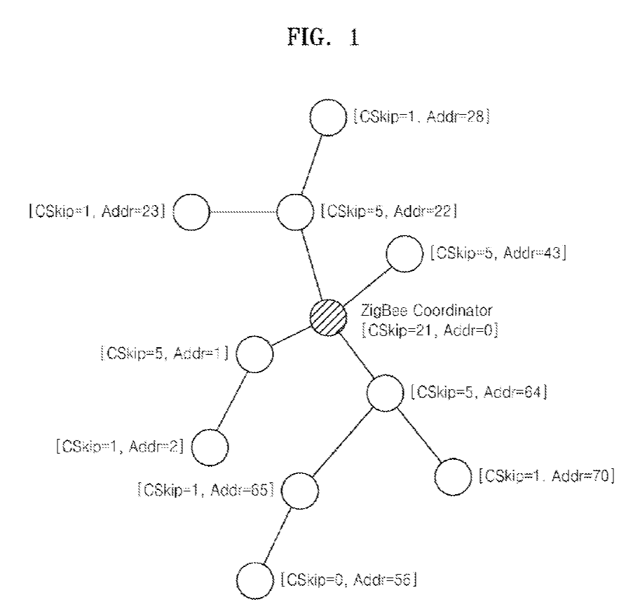

FIG. 1 is a diagram illustrating calculated address values of nodes in an ad-hoc network according to an embodiment of the present invention.

FIG. 1 illustrates a plurality of network nodes, which are included in the ad-hoc network and communicate with each other. The plurality of network nodes includes a root node, which has an address value of 0, and child nodes, and the child nodes may also include other lower nodes as child nodes. Here, when the ad-hoc network has a tree structure, the ad-hoc network has the maximum permissible depth (Lm), each parent node may have the maximum Cm child nodes, and from among the child nodes, the maximum Rm child nodes can be joined to a router.

Here, when a lower node requests for join, the parent node assigns an address value (Addr) of the lower node by using a Cskip value of the parent node. The Cskip value can be obtained by using Equation 1 below.

$$\begin{matrix}Equation 1 & \\ Cskip ( d ) = \{ \begin{matrix}1 + Cm ( Lm - d - 1 ) , if Rm = 1 \\ \frac{1 + Cm - Rm - {CmRm}^{Lm - d - 1}}{1 - Rm} , otherwise\end{matrix} & [ Math . 1 ]\end{matrix}$$

Here, d denotes a level value of each node.

The address value of the lower node is calculated using the Cskip value, and when the lower node is a router, the address value of the lower node is calculated using Equation 2 below.

[Math.2]

An=1+Cskip×(k−1) Equation 2

Here, k denotes a join order and Cskip denotes a value of the parent node.

When the lower node is an end node, the address value of the lower node is calculated using Equation 3 below.

[Math.3]

An=Aₚₐᵣₑₙₜ+Cskip(d)×Rm+n Equation 3

Here, 1<=n<=(Cm−Rm) and Aₚₐᵣₑₙₜₛ denotes an address value of the parent node.

As a result, when the ad-hoc network having a tree structure as illustrated in FIG. 1 has 4 maximum number of child node (Cm), 4 child node (Rm) that can be joined to a router, and 3 maximum permissible depth (Lm), the nodes joined to the root node, which has an address value of 0, respectively have address values of 1, 22, 43, and 64.

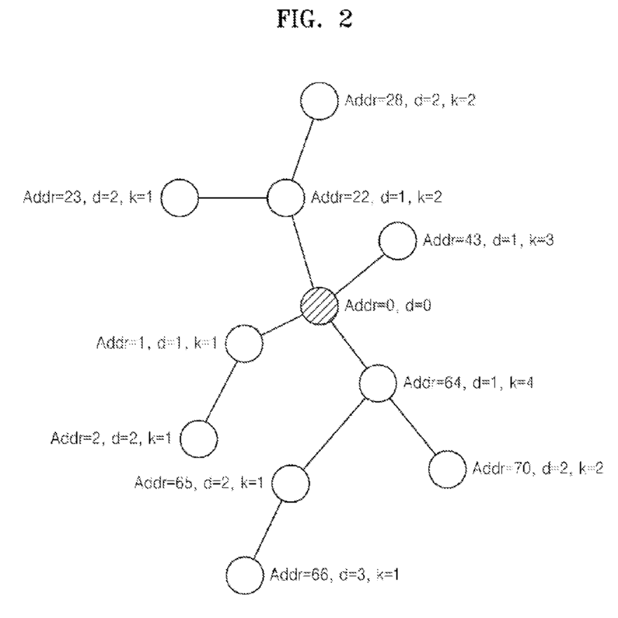

FIG. 2 is a diagram illustrating address values, level values, and join order values of nodes in an ad-hoc network according to an embodiment of the present invention.

In FIG. 2, a level value (distance between a root node to each node, d) of each node and a join order value (k) of each node joined to a parent node are illustrated with the address value (Addr) of each node calculated in FIG. 1.

The level value (d), which shows a distance from each node to the root node, is assigned to each node in a communication system and the join order value (k), which shows the order in which each node has been joined to a parent node, is assigned to each node in a certain level value. As a result, each node includes an address value, a level value, and a join order value.

FIG. 3 is a diagram illustrating calculated channel values of nodes in an ad-hoc network according to an embodiment of the present invention.

FIG. 3 is a result of calculating the channel values of the nodes by using the address values, the level values, and the join order values of the nodes illustrated in FIG. 2. Generally, the channel values are determined by above calculation when a beacon signal is received from a parent node.

Communication channels need to be evenly assigned to all nodes in a communication system so that cu-channel interference is reduced. However, when the number of nodes increases, the communication channels for the nodes may overlap while the communication channels are assigned because of a limited number of the communication channels. Accordingly, the overlapping should be minimized by evenly generating the communication channels. Consequently in the present invention, communication channels are assigned to certain nodes based on current level values (d) of the certain nodes, join order values (k) of the certain nodes to a parent node, a channel value (Pₛₗₒₜ) of the parent node, and the maximum value of usable channels (Smax).

For example, the channel values of nodes in the communication system can be calculated by using Equation 4 below.

[Math.4]

Channel=(Address×d+Pₛₗₒₜ+k)%S_{MAX} Equation 4

In FIG. 3, a network wherein Cm=4, Rm=4, Lm=3, Smax=32 is illustrated. Here, according to above method, channel 0 is assigned to the root node, and a channel slot 2, a channel slot 24, a channel slot 14, and a channel slot 4 are respectively assigned to a node having an address value 1, a node having an address value 22, a node having an address value 43, and a node having an address value 64, where the nodes are joined to the root node. Also, channel values, calculated using Equation 4, are assigned to other child nodes.

However, even if Equation 4 is used, there may be nodes using the same channel slot when a lot of nodes operate in a limited space. In this case, a method of preventing or avoiding collision of channel slots is required.

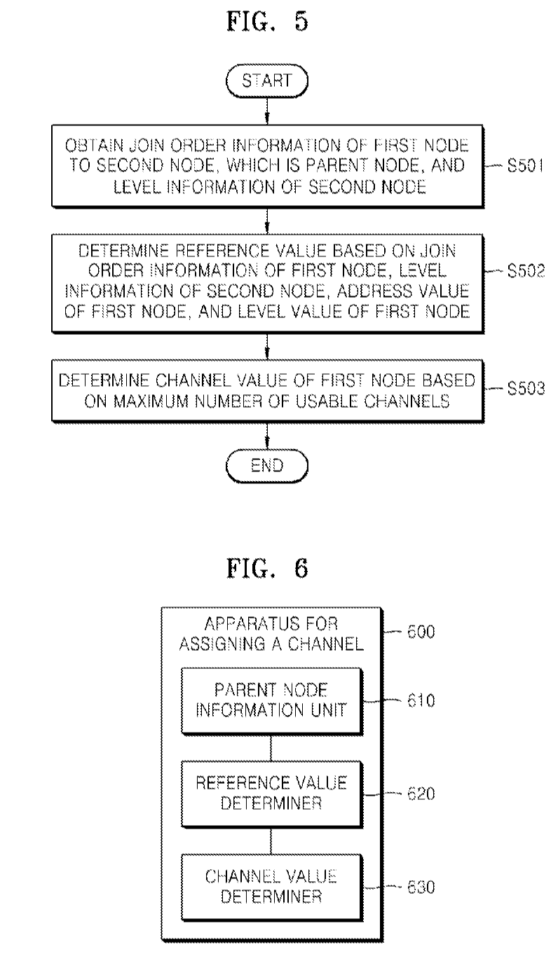

FIG. 5 is a flowchart illustrating a method of assigning a channel for transmitting a beacon in an ad-hoc network according to an embodiment of the present invention.

The method of FIG. 5 illustrates in detail the method of assigning a channel for each node by using an address value and an level value of each node, join order value of each node to a parent node, and a level value of the parent node illustrated in FIG. 3.

Referring to FIG. 5, join order information which is information on the order in which a first node has been joined to a second node, which is a parent node, and level information of the second node in an ad-hoc network are obtained in operation S501. In operation S502, a reference value for setting a channel that is to be assigned to the first node is determined based on an address value of the first node, which is determined based on the join order information and the level information, a level value of the first node, a channel value of the second node, which is determined based on the level information, and the join order information. In operation S503, a channel value of the first node is determined by dividing the reference value by the maximum number of usable channels in the ad-hoc network.

In operation S502, the reference value may be determined to a value, which is obtained by multiplying the address value of the first node and the level value of the first node and adding the channel value of the second node and the join order information to the result of the multiplying.

The join order information may be determined based on a time when the first node is joined to the second node according to transmission of a join request message of the first node and the join request message may be transmitted when a predetermined time is passed after the first node discovers the second node.

The join order information may be changed to new join order information by the second node when the determined channel value of the first node is used by another node, and the channel value of the first node may be used when the first node transmits a beacon.

1. A method of assigning a channel, the method comprising:
obtaining join order information which is information on the order in which a first node has been joined to a second node, which is a parent node, and level information of the second node in an ad-hoc network;
determining a reference value for setting a channel that is to be assigned to the first node based on an address value of the first node, which is determined based on the join order information and the level information, a level value of the first node, a channel value of the second node, which is determined based on the level information, and the join order information; and
determining a channel value of the first node by dividing the reference value by the maximum number of usable channels in the ad-hoc network.

2. The method of claim 1, wherein in the determining of the reference value, the reference value is determined to a value, which is obtained by multiplying the address value of the first node and the level value of the first node and adding the channel value of the second node and the join order information to the result of the multiplying.

3. The method of claim 1, wherein the join order information is determined based on a time when the first node is joined to the second node according to transmission of a join request message of the first node, wherein the join request message is transmitted when a predetermined time is passed after the first node discovers the second node.

4. The method of claim 1, wherein the join order information is changed to new join order information by the second node when the determined channel value of the first node is used by another node, and the channel value of the first node is determined based on the newly changed join order information.

5. The method of claim 1, wherein the channel value of the first node is used when the first node transmits a beacon.

6. An apparatus for assigning a channel, the apparatus comprising:
a parent node information unit, which obtains join order information which is information on the order in which a first node has been joined to a second node, which is a parent node, and level information of the second node in an ad-hoc network;
a reference value determiner, which determines a reference value for setting a channel that is to be assigned to the first node based on an address value of the first node, which is determined based on the join order information and the level information, a level value of the first node, a channel value of the second node, which is determined based on the level information, and the join order information; and
a channel value determiner, which determines a channel value of the first node by dividing the reference value by the maximum number of usable channels in the ad-hoe network.

7. The apparatus of claim 6, wherein the reference value determiner determines the reference value, which is obtained by multiplying the address value of the first node and the level value of the first node and adding the channel value of the second node and the join order information to the result of the multiplying.

8. The apparatus of claim 6, wherein the join order information
is determined based on a time when the first node is joined to the second node according to transmission of a join request message of the first node, wherein the join request message is transmitted when a predetermined time is passed after the first node discovers the second node.

9. The apparatus of claim 6, wherein the join order information is changed to new join order information by the second node when the determined channel value of the first node is used by another node, and the channel value of the first node is determined based on the newly changed join order information.

10. The apparatus of claim 6, wherein the channel value of the first node is used when the first node transmits a beacon.
